(19) United States
(12) Patent Application Publication
(10) Pub. No.: US 2026/0118681 A1
(43) Pub. Date: Apr. 30, 2026

(54) VR EYEPIECE SYSTEM

(71) Applicant: ZHEJIANG SUNNY OPTICS CO., LTD., Ningbo (CN)

(72) Inventors: Linwei WU, Yuyao City (CN); Xiaobin ZHANG, Yuyao City (CN); Lin HUANG, Yuyao City (CN); Yinfang JIN, Yuyao City (CN); Liefeng ZHAO, Yuyao City (CN)

(73) Assignee: ZHEJIANG SUNNY OPTICS CO., LTD., Ningbo (CN)

(21) Appl. No.: 19/254,945

(22) Filed: Jun. 30, 2025

(30) Foreign Application Priority Data
Oct. 28, 2024 (CN) 202411509863.1

(51) Int. Cl. G02B 27/01; G02B 3/00; G02B 3/02

(52) U.S. Cl. CPC G02B 27/0172; G02B 3/0075; G02B 3/02; G02B 27/0176; G02B 2027/0116; G02B 2027/015; G02B 2027/0152

(57) ABSTRACT

The disclosure provides a VR eyepiece system. The VR eyepiece system sequentially includes a first lens, a connecting assembly, a second lens, a diffractive optical element, a third lens, a semi-transparent and semi-reflective film and a display screen, where the diffractive optical element is closely fitted to an image-side surface of the second lens; the display screen is located on an imaging surface of the VR eyepiece system; F1, a combined focal length of the first lens, the connecting assembly, the second lens and the diffractive optical element, f3, an effective focal length of the third lens, and f, an effective focal length of the VR eyepiece system satisfy: 0.024≤f/(F1−f3)≤0.043; and the F1 and the f3 satisfy: −2.066≤f3/F1≤−0.036. The disclosure solves problems of low definition and a large chromatic aberration at an edge field of view of VR glasses in the related art.

### CROSS-REFERENCE TO RELATED APPLICATION(S)

This application claims priority to Chinese Patent Application No. 202411509863.1 filed on Oct. 28, 2024, the entire contents of each of which are incorporated herein by reference for all purposes. No new matter has been introduced.

### FIELD

The disclosure relates to the technical field of optical lenses, and in particular to a VR eyepiece system.

### BACKGROUND

In the virtual reality head-mounted display (VRHD) released on the market today, a size of VR glasses is usually reduced by using lens systems with an optical design (pancake optics system) of a short focal length and a small size. However, the VR glasses are still heavy and less comfortable for users to wear. Moreover, the pancake optics system is designed to have a small field of view. When a user rotates his or her eyes at a large angle, the VR glasses will produce problems of lower picture definition and greater chromatic aberration, causing the user to have a poor visual experience of the edge field of view and not be able to wear them for a long period of time.

That is to say, a problem that a VR eyepiece system in the related art has poor wearing comfort and poor imaging quality of an edge field of view exists.

### SUMMARY

Some embodiments of the disclosure provide a virtual reality (VR) eyepiece system, so as to solve a problem that a VR eyepiece system in the related art has poor wearing comfort and poor imaging quality of an edge field of view.

In an embodiment of the disclosure, a VR eyepiece system is provided. The VR eyepiece system sequentially includes, from an eye-side surface of the VR eyepiece system to an imaging surface of the VR eyepiece system: a first lens; a connecting assembly, where the connecting assembly sequentially includes, from the eye-side surface of the VR eyepiece system to the imaging surface of the VR eyepiece system: a first glue layer, a linear polarizing plate, a second glue layer, a polarizing reflective film, a third glue layer, a quarter-wave plate and a fourth glue layer; a second lens, where the first lens and the second lens are glued together through the connecting assembly, the second lens has a positive refractive power, and an image-side surface of the second lens is a planar surface; a diffractive optical element, where the diffractive optical element is closely fitted to the image-side surface of the second lens, the diffractive optical element has a diffractive optical surface, and the diffractive optical surface is of a planar structure with a preset thickness; a third lens, where the third lens has a negative refractive power, an eye-side surface of the third lens is a convex surface, an image-side surface of the third lens has a semi-transparent and semi-reflective film, and the diffractive optical surface faces the eye-side surface of the third lens; and a display screen, where the display screen is located on the imaging surface of the VR eyepiece system; where the first lens, the second lens, and the third lens are coaxially arranged; F1, a combined focal length of the first lens, the connecting assembly, the second lens, and the diffractive optical element, f3, an effective focal length of the third lens, and f, an effective focal length of the VR eyepiece system satisfy: 0.024≤f/(F1−f3)≤0.043; and F1, the combination focal length of the first lens, the connecting assembly, the second lens and the diffractive optical element, and f3, the effective focal length of the third lens satisfy: −2.066≤f3/F1≤−0.036. In an embodiment, thicknesses of the first glue layer, the linear polarizing plate, the second glue layer, the polarizing reflective film, the third glue layer, the quarter-wave plate and the fourth glue layer are each greater than 0 mm and less than 0.06 mm.

In an embodiment, the image-side surface of the third lens is a planar surface.

In an embodiment, TTL, an on-axis distance from an eye-side surface of the first lens to the imaging surface of the VR eyepiece system, and ED, an on-axis distance from an eye to the eye-side surface of the first lens satisfy: 1.155≤ED/TTL≤1.221.

In an embodiment, EPD, an entrance pupil diameter of the VR eyepiece system, and ImgH, half of a diagonal length of an effective pixel region on the imaging surface of the VR eyepiece system satisfy: 2.715≤ImgH/EPD≤3.062.

In an embodiment, f3, the effective focal length of the third lens and fi, an effective focal length of an ith lens satisfy: |f3|<|f1|, and i takes 1, 2.

In an embodiment, f, the effective focal length of the VR eyepiece system, and f3, the effective focal length of the third lens satisfy: −15.572≤f3/f≤−1.471.

In an embodiment, f1, an effective focal length of the first lens, and f2, an effective focal length of the second lens satisfy: −2.829≤f2/f1≤5.776.

In an embodiment, f, the effective focal length of the VR eyepiece system, and TTL, an on-axis distance from an eye-side surface of the first lens to the imaging surface of the VR eyepiece system satisfy: 0.904≤TTL/f≤1.039.

In an embodiment, CT1, a center thickness of the first lens, CT2, a center thickness of the second lens, N1, a refractive index of the first lens, and N2, a refractive index of the second lens satisfy: −0.653 mm≤(CT2*N2)−(CT1*N1)≤3.756 mm.

In an embodiment, ET1, an edge thickness of the first lens, ET2, an edge thickness of the second lens, and ET3, an edge thickness of the third lens satisfy: 2.100≤ (ET1+ET2)/ET3≤5.437.

In an embodiment, Tr1r4, an on-axis distance from the eye-side surface of the first lens to the image-side surface of the second lens, and CT3, a center thickness of the third lens satisfy: 1.483≤Tr1r4/CT3≤1.703.

In an embodiment, R3, a radius of curvature of an eye-side surface of the second lens, and R5, a radius of curvature of the eye-side surface of the third lens satisfy: −1.283≤R3/R5≤2.857.

In an embodiment, TD, an on-axis distance from the eye-side surface of the first lens to the image-side surface of the third lens, and T23, an on-axis distance of an air gap between the second lens and the third lens satisfy: 0.121≤T23/TD≤0.188.

By using the technical solution of the disclosure, the VR eyepiece system sequentially includes, from an eye-side surface of the VR eyepiece system to an imaging surface of the VR eyepiece system: a first lens, a connecting assembly, a second lens, a diffractive optical element, a third lens, a display screen. The connecting assembly sequentially includes, from the eye-side surface of the VR eyepiece system to the imaging surface of the VR eyepiece system: a first glue layer, a linear polarizing plate, a second glue layer, a polarizing reflective film, a third glue layer, a quarter-wave plate and a fourth glue layer. The first lens and the second lens are glued together through the connecting assembly, the second lens has a positive refractive power, and an image-side surface of the second lens is a planar surface. The diffractive optical element is closely fitted to the image-side surface of the second lens, the diffractive optical element has a diffractive optical surface, and the diffractive optical surface is of a planar structure with a preset thickness.

The third lens has a negative refractive power, an eye-side surface of the third lens is a convex surface, an image-side surface of the third lens has a semi-transparent and semi-reflective film, and the diffractive optical surface faces the eye-side surface of the third lens. The display screen is located on the imaging surface of the VR eyepiece system. The first lens, the second lens, and the third lens are coaxially arranged; F1, a combined focal length of the first lens, the connecting assembly, the second lens, and the diffractive optical element, f3, an effective focal length of the third lens, and f, an effective focal length of the VR eyepiece system satisfy: 0.024≤f/(F1−f3)≤0.043; and F1, the combination focal length of the first lens, the connecting assembly, the second lens and the diffractive optical element, and f3, the effective focal length of the third lens satisfy: −2.066≤f3/F1≤−0.036.

The VR eyepiece system in the disclosure uses three lenses. The first lens, the second lens, and the third lens are coaxially arranged. In order to improve a visual experience of the edge field of view of a user, the connecting assembly is configured to cement the first lens and the second lens. The connecting assembly sequentially includes the first glue layer, the linear polarizing plate, the second glue layer, the polarizing reflective film, the third glue layer, the quarter-wave plate and the fourth glue layer. The linear polarizing plate, the polarizing reflective film and the quarter-wave plate glued between the first lens and the second lens are configured for controlling a polarization state, a phase and reflection characteristics of an optical path, so as to implement refraction and reflection of the optical path. The second lens has a positive refractive power. The image-side surface of the second lens is set to be a planar surface. Thus the diffractive optical element is able to be closely fitted to the image-side surface of the second lens conveniently. The diffractive optical surface is set towards the eye-side surface of the third lens, so as to improve resolution of imaging. The third lens of the VR eyepiece system has a negative refractive power, and the image-side surface of the third lens has a semi-transparent and semi-reflective film, such that a field of view of the VR eyepiece system is able to be increased, an optical path of the VR eyepiece system is able to be reduced, and lens thicknesses and weights are able to be compressed. The display screen is located on the imaging surface of the VR eyepiece system to facilitate formation of clear images. A ratio of f3, the effective focal length of the third lens to F1, the combined focal length of the first lens, the connecting assembly, the second lens and the diffractive optical element is small, which is beneficial to control over a weight of the VR eyepiece system. By controlling a ratio of f, the effective focal length of the VR eyepiece system to a difference between the f3 and the F1, the center thickness and the edge thickness of the VR eyepiece system under an optical design of a pancake optics system are indirectly controlled, such that the wearing comfort of a user is increased, and a bearing feeling of a head of the user is reduced. Furthermore, by reasonably controlling a relationship of focal lengths of the first lens, the connecting assembly, the second lens, the diffractive optical element, the third lens and the VR eyepiece system, imaging performance of the VR eyepiece system is able to be better improved.

### BRIEF DESCRIPTION OF DRAWINGS

The accompanying drawings of the specification forming a part of the disclosure serve to provide a further understanding of the disclosure, and the illustrative examples of the disclosure and the description of the illustrative examples serve to explain the disclosure and are not to be construed as unduly limiting the disclosure. In the drawings:

FIG. 1 illustrates a schematic structural diagram of a virtual reality (VR) eyepiece system according to Example 1 of the disclosure;

FIG. 2 illustrates a longitudinal aberration curve of the VR eyepiece system of FIG. 1;

FIG. 3 illustrates an astigmatism curve of the VR eyepiece system of FIG. 1;

FIG. 4 illustrates a distortion curve of the VR eyepiece system of FIG. 1;

FIG. 5 illustrates a modulation transfer function (MTF) curve of the VR eyepiece system of FIG. 1;

FIG. 6 illustrates a schematic structural diagram of a VR eyepiece system according to Example 2 of the disclosure;

FIG. 7 illustrates a longitudinal aberration curve of the VR eyepiece system of FIG. 6;

FIG. 8 illustrates an astigmatism curve of the VR eyepiece system of FIG. 6;

FIG. 9 illustrates a distortion curve of the VR eyepiece system of FIG. 6;

FIG. 10 illustrates an MTF curve of the VR eyepiece system of FIG. 6;

FIG. 11 illustrates a schematic structural diagram of a VR eyepiece system according to Example 3 of the disclosure;

FIG. 12 illustrates a longitudinal aberration curve of the VR eyepiece system of FIG. 11;

FIG. 13 illustrates an astigmatism curve of the VR eyepiece system of FIG. 11;

FIG. 14 illustrates a distortion curve of the VR eyepiece system of FIG. 11;

FIG. 15 illustrates an MTF curve of the VR eyepiece system of FIG. 11;

FIG. 16 illustrates a schematic structural diagram of a VR eyepiece system according to Example 4 of the disclosure;

FIG. 17 illustrates a longitudinal aberration curve of the VR eyepiece system of FIG. 16;

FIG. 18 illustrates an astigmatism curve of the VR eyepiece system of FIG. 16;

FIG. 19 illustrates a distortion curve of the VR eyepiece system of FIG. 16;

FIG. 20 illustrates an MTF curve of the VR eyepiece system of FIG. 16;

FIG. 21 illustrates a sectional view of a diffractive optical element of a VR eyepiece system according to an optional example of the disclosure; and

FIG. 22 illustrates a front view of a diffractive optical surface of FIG. 21.

### THE DRAWINGS INCLUDE THE FOLLOWING REFERENCE NUMERALS

E1, first lens; S1, eye-side surface of first lens; S2, image-side surface of first lens (eye-side surface of first glue layer); LP, linear polarizing plate; S3, image-side surface of first glue layer (eye-side surface of linear polarizing plate); S4, image-side surface of linear polarizing plate (eye-side surface of second glue layer); RP, polarizing reflective film; S5, image-side surface of second glue layer (eye-side surface of polarizing reflective film); S6, image-side surface of polarizing reflective film (eye-side surface of third glue layer); QWP, quarter-wave plate; S7, image-side surface of third glue layer (eye-side surface of quarter-wave plate); S8, image-side surface of quarter-wave plate (eye-side surface of fourth glue layer); E2, second lens; S9, eye-side surface of second lens (image-side surface of fourth glue layer); S10, image-side surface of second lens (eye-side surface of diffractive optical element); DOE, diffractive optical element; S11, image-side surface of diffractive optical element; E3, third lens; S12, eye-side surface of third lens; S13, image-side surface of third lens; BS, semi-transparent and semi-reflective film; IMG, display screen; and S14, imaging surface of VR eyepiece system.

### DESCRIPTION OF EMBODIMENTS

It should be noted that the examples in the disclosure and features in the examples is able to be combined without conflicts. The disclosure will be described in detail below with reference to the accompanying drawings in conjunction with examples.

It should be noted that unless otherwise defined, all technical and scientific terms used in the disclosure have the same meanings usually understood by the general technical personnel in the technical field of the disclosure.

In the disclosure, directional terms such as “upper”, “lower”, “top”, and “bottom” are used generally with respect to directions shown in the drawings, or with respect to vertical, perpendicular, or gravitational directions of components, without being described to the contrary. Similarly, for ease of understanding and description, “inner” and “outer” refer to inner and outer relative to contours of the components, but the above directional terms are not intended to limit the disclosure.

It should be noted that throughout this specification, the recitations of first, second, third, etc. are used merely to distinguish one feature from another and do not represent any limitation on the feature. Thus, the first lens discussed below may also be referred to as the second lens or the third lens without departing from the teachings of the disclosure.

In the accompanying drawings, the thickness, size, and shape of the lens have been slightly exaggerated for ease of illustration. Specifically, a spherical shape or an aspheric shape shown in the drawings is shown by some instances. That is to say that the spherical or aspheric shape is not limited to the spherical or aspheric shape shown in the accompanying drawings. The drawings are by way of example only and not strictly to scale.

A paraxial region refers to a region near an optical axis herein. Under the condition that a surface of a lens is a convex surface and a position of the convex surface is not defined, the surface of the lens is a convex surface at least in the paraxial region; and under the condition that the surface of the lens is a concave surface and the position of the concave surface is not defined, the surface of the lens is a concave surface at least in the paraxial region. A surface type of concave or convex at a paraxial region may be determined by means of positive or negative of a value of R (R refers to a radius of curvature of the paraxial region, and generally refers to a value of R on a lens data in optical software) according to a determination method of a person skilled in the art. As for an eye-side surface, when the value of R is positive, the eye-side surface is determined to be a convex surface, and when the value of R is negative, the eye-side surface is determined to be a concave surface. As for a display-side surface, when the value of R is positive, the display-side surface is determined to be a concave surface, and when the value of R is negative, the display-side surface is determined to be a convex surface.

In order to solve a problem that a VR eyepiece system in the related art has poor wearing comfort and poor imaging quality of an edge field of view, the disclosure provides a VR eyepiece system.

### Embodiment 1

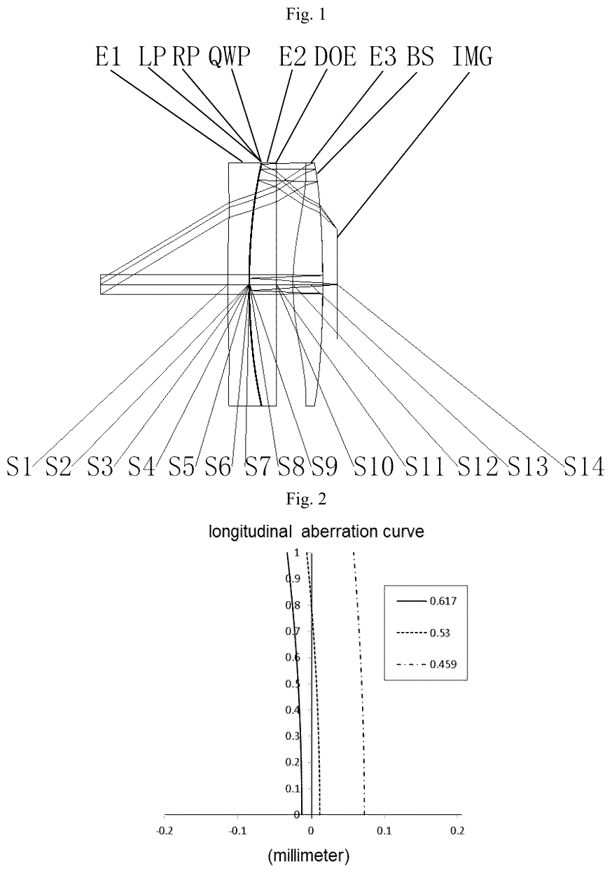

As shown in FIGS. 1 to 22, the disclosure provides a VR eyepiece system. The VR eyepiece system sequentially includes, from an eye-side surface of the VR eyepiece system to an imaging surface of the VR eyepiece system: a first lens, a connecting assembly, a second lens, a diffractive optical element, a third lens, a display screen. The connecting assembly sequentially includes, from the eye-side surface of the VR eyepiece system to the imaging surface of the VR eyepiece system: a first glue layer, a linear polarizing plate, a second glue layer, a polarizing reflective film, a third glue layer, a quarter-wave plate and a fourth glue layer. The first lens and the second lens are glued together through the connecting assembly, the second lens has a positive refractive power, and an image-side surface of the second lens is a planar surface. The diffractive optical element is closely fitted to the image-side surface of the second lens, the diffractive optical element has a diffractive optical surface, and the diffractive optical surface is of a planar structure with a preset thickness. The third lens has a negative refractive power, an eye-side surface of the third lens is a convex surface, an image-side surface of the third lens has a semi-transparent and semi-reflective film, and the diffractive optical surface faces the eye-side surface of the third lens. The display screen is located on the imaging surface of the VR eyepiece system. The first lens, the second lens, and the third lens are coaxially arranged; F1, a combined focal length of the first lens, the connecting assembly, the second lens, and the diffractive optical element, f3, an effective focal length of the third lens, and f, an effective focal length of the VR eyepiece system satisfy: 0.024≤f/(F1−f3)≤0.043; and F1, the combination focal length of the first lens, the connecting assembly, the second lens and the diffractive optical element, and f3, the effective focal length of the third lens satisfy: −2.066≤f3/F1≤−0.036.

The VR eyepiece system in the disclosure uses three lenses. The first lens, the second lens, and the third lens are coaxially arranged. In order to improve a visual experience of the edge field of view of a user, the connecting assembly is glued between the first lens and the second lens. The connecting assembly sequentially includes the first glue layer, the linear polarizing plate, the second glue layer, the polarizing reflective film, the third glue layer, the quarter-wave plate and the fourth glue layer. The linear polarizing plate, the polarizing reflective film and the quarter-wave plate glued between the first lens and the second lens are configured for controlling a polarization state, a phase and reflection characteristics of an optical path, so as to implement refraction and reflection of the optical path. The second lens has a positive refractive power. The image-side surface of the second lens is set to be a planar surface. Thus the diffractive optical element is able to be closely fitted to the image-side surface of the second lens conveniently. The diffractive optical surface is set towards the eye-side surface of the third lens, so as to improve resolution of imaging. The third lens of the VR eyepiece system has a negative refractive power, and the image-side surface of the third lens has a semi-transparent and semi-reflective film, such that a field of view of the VR eyepiece system is able to be increased, an optical path of the VR eyepiece system is able to be reduced, and lens thicknesses and weights are able to be compressed.

The display screen is located on the imaging surface of the VR eyepiece system to facilitate formation of clear images. A ratio of f3, the effective focal length of the third lens to F1, the combined focal length of the first lens, the connecting assembly, the second lens and the diffractive optical element is small, which is beneficial to control over a weight of the VR eyepiece system. By controlling a ratio of f, the effective focal length of the VR eyepiece system to a difference between the f3 and the F1, the center thickness and the edge thickness of the VR eyepiece system under an optical design of a pancake optics system are indirectly controlled, such that the wearing comfort of a user is increased, and a bearing feeling of a head of the user is reduced. Furthermore, by reasonably controlling a focal length relationship of the first lens, the connecting assembly, the second lens, the diffractive optical element, the third lens and the VR eyepiece system, imaging performance of the VR eyepiece system is able to be better improved.

In the embodiment, thicknesses of the first glue layer, the linear polarizing plate, the second glue layer, the polarizing reflective film, the third glue layer, the quarter-wave plate and the fourth glue layer are each greater than 0 mm and less than 0.06 mm. By limiting the thickness of each part of the connecting assembly to a reasonable range, a composite thickness of the connecting assembly is able to be controlled to be smaller, and performance reduction of the connecting assembly due to excessive thickness is able to be further avoided. Furthermore, only one composite of the connecting assembly is provided, and an optical path transmittance of the VR eyepiece system is relatively high, which effectively improves light efficiency of the VR eyepiece system.

In the embodiment, the image-side surface of the third lens is a planar surface. By setting the image-side surface of the second lens and the image-side surface of the third lens to be planar surfaces, a maximum deviation of wavefront of the VR eyepiece system is able to be effectively reduced, and imaging quality of the VR eyepiece system is able to be improved. Moreover, sensitivity of single-sided eccentricity of the second lens and the third lens is able to be reduced, and a performance difference between a theoretical value and a design value caused by a manufacturing process is able to be effectively reduced.

In the embodiment, TTL, an on-axis distance from an eye-side surface of the first lens to the imaging surface of the VR eyepiece system, and ED, an on-axis distance from an eye to the eye-side surface of the first lens satisfy: 1.155≤ED/TTL≤1.221. By controlling the on-axis distance from the eye-side surface of the first lens to the imaging surface of the VR eyepiece system, a size and weight of the VR eyepiece system is able to be effectively controlled, such that a structure of the VR eyepiece system is able to be compacted, and integration is convenient. Moreover, controlling the on-axis distance from an eye to the eye-side surface of the first lens is able to be applied to a wider user population. Furthermore, by limiting ED/TTL to a reasonable range, light rays are able to be maximized to reduce a bearing feeling of the head, such that a sight of a user remains stable, not influenced by external interference or body movement. Better visual effects and comfortable observation experience are able to be obtained.

In the embodiment, EPD, an entrance pupil diameter of the VR eyepiece system, and ImgH, half of a diagonal length of an effective pixel region on the imaging surface of the VR eyepiece system satisfy: 2.715≤ImgH/EPD≤3.062. Setting the entrance pupil diameter of the VR eyepiece system to 4 mm allows more light rays to pass through the VR eyepiece system. The entrance pupil diameter of the VR eyepiece system is greater than an average pupil diameter of a human eye, such that a visual experience of users with larger eyes is better. By controlling the diagonal length of the effective pixel region on the imaging surface of the VR eyepiece system, a size of the display screen is able to be shortened to reduce cost of the display screen. Moreover, by limiting ImgH/EPD to a reasonable range, the VR eyepiece systems are able to achieve high pixel, high resolution, and high definition.

In the embodiment, f3, the effective focal length of the third lens and fi, an effective focal length of an ith lens satisfy: |f3|<|f1|, and i takes 1, 2. By controlling the effective focal length of the third lens to be less than both of the effective focal lengths of the first lens and the second lens, a problem of light rays divergence generated when the first lens has a negative refractive power is able to be further alleviated. Moreover, on the premise of keeping the thickness of the third lens small, light rays emitted from the optical path to the imaging surface of the VR eyepiece system is converged, which is beneficial to reduction in an image height of the imaging surface of the VR eyepiece system.

In the embodiment, f, the effective focal length of the VR eyepiece system, and f3, the effective focal length of the third lens satisfy: −15.572≤f3/f≤−1.471. By limiting f3/f to a reasonable range and controlling it to a small value, a light rays condensing ability of the VR eyepiece system is able to be mainly focused on the third lens. Thus overall flatness of the first lens, the connecting assembly, the second lens and the diffractive optical element is high, process difficulty of processing the VR eyepiece system is effectively reduced, and only the third lens needs to be controlled in design.

In the embodiment, f1, an effective focal length of the first lens, and f2, an effective focal length of the second lens satisfy: −2.829≤f2/f1≤5.776. By limiting f2/f1 to a reasonable range, a bending effect of light rays is able to be mainly concentrated on the first lens, such that a propagation range of light rays is limited, scattering and interference of light rays in the VR eyepiece system are reduced, and resolution, contrast, color reproducibility and imaging quality of the VR eyepiece system are further improved.

In the embodiment, f, the effective focal length of the VR eyepiece system, and TTL, an on-axis distance from an eye-side surface of the first lens to the imaging surface of the VR eyepiece system satisfy: 0.904≤TTL/f≤1.039. By limiting TTL/f to a reasonable range, an aberration of the VR eyepiece system is able to be effectively improved, a luminous flux of the VR eyepiece system is able to be increased, and the imaging quality of the VR eyepiece system is able to be optimized.

In the embodiment, CT1, a center thickness of the first lens, CT2, a center thickness of the second lens, N1, a refractive index of the first lens, and N2, a refractive index of the second lens satisfy: −0.653 mm≤(CT2*N2)−(CT1*N1)≤3.756 mm. By limiting (CT2*N2)−(CT1*N1), an optical path difference between the second lens and the first lens to a reasonable range and reasonably matching high refractive index materials and low refractive index materials, the optical path difference between the second lens and the first lens is able to be reduced on the premise of effectively correcting a chromatic aberration. Moreover, when a field of view of the first lens is increased, a light beam is condensed through the second lens and the third lens, such that the weight of the VR eyepiece system is reduced, and immersion of the user is greatly improved. In the embodiment, ET1, an edge thickness of the first lens, ET2, an edge thickness of the second lens, and ET3, an edge thickness of the third lens satisfy: 2.100≤(ET1+ET2)/ET3≤5.437. By limiting (ET1+ET2)/ET3 to a reasonable range, differences in edge thicknesses of the first lens, the connecting assembly, the second lens, the diffractive optical element and the third lens are small, such that a propagation path of light rays in the VR eyepiece system is able to be more uniform, and then the aberration and distortion of the VR eyepiece system is able to be corrected, and quality and accuracy of images are able to be improved. Furthermore, optical problems such as aberration, defocus and scattering of the VR eyepiece systems are able to also be minimized. In the embodiment, Tr1r4, an on-axis distance from the eye-side surface of the first lens to the image-side surface of the second lens, and CT3, a center thickness of the third lens satisfy: 1.483≤Tr1r4/CT3≤1.703. By limiting Tr1r4/CT3 to a reasonable range, a difference between the on-axis distance from the eye-side surface of the first lens to the image-side surface of the second lens and the center thickness of the third lens is small, such that weight distribution of the VR eyepiece system is uniform, and the wearing comfort of the user is enhanced. Moreover, image field flatness and the imaging quality of the VR eyepiece system are balanced, and better image clarity and resolution are obtained.

In the embodiment, R3, a radius of curvature of an eye-side surface of the second lens, and R5, a radius of curvature of the eye-side surface of the third lens satisfy: −1.283≤R3/R5≤2.857. By limiting R3/R5 to a reasonable range, the effective focal length of the VR eyepiece system is effectively controlled, such that convergence of light rays with a large field of view and miniaturization of a VR eyepiece system headset are facilitated.

In the embodiment, TD, an on-axis distance from the eye-side surface of the first lens to the image-side surface of the third lens, and T23, an on-axis distance of an air gap between the second lens and the third lens satisfy: 0.121≤T23/TD≤0.188. By limiting T23/TD to a reasonable range, a ratio of the on-axis distance of the air gap between the second lens and the third lens to the on-axis distance from the eye-side surface of the first lens to the image-side surface of the third lens is small, such that the optical path and a total length of the VR eyepiece system are able to be further shortened, which facilitates high integration of the VR eyepiece system.

The embodiment may further include other parameter formulas in the first embodiment, which are not repeated herein.

The VR eyepiece systems in the disclosure may employ a plurality of lenses, for example, three lenses described above. The effective focal length and the surface type of each lens, the center thickness of each lens, the on-axis distance between the lenses, etc. are reasonably distributed, thereby effectively increasing an aperture of the VR eyepiece system, reducing sensitivity of a lens, and improving machinability of the lens, which makes the VR eyepiece system more beneficial to production and machining and suitable for portable electronic apparatuses such as smart phones.

In the disclosure, a mirror surface of at least one of lenses is an aspheric mirror surface. The aspheric lens is characterized in that the curvature is continuously changed from a center of the lens to a periphery of the lens. Different from a spherical lens with a constant curvature from the center of the lens to the periphery of the lens, the aspheric lens has a better feature of a radius of curvature and has the advantages of improving distortion aberration and astigmatism aberration. After the aspheric lens is configured, aberration occurring during imaging may be eliminated as much as possible, thereby improving the imaging quality.

However, it should be understood by those skilled in the art that the number of lenses constituting the VR eyepiece system may be varied to obtain various results and advantages described in this specification without departing from the claimed technical solution of the disclosure. For example, although described with three lenses as an example in embodiment, the VR eyepiece system is not limited to including three lenses. The VR eyepiece system may also include other numbers of lenses if desired.

FIG. 1 illustrates a schematic structural diagram of a portion of a VR eyepiece system according to the disclosure. Various optical elements of the VR eyepiece system are labeled in FIG. 1. The first lens is E1, the linear polarizing plate is LP, the polarizing reflective film is RP, the quarter-wave plate is QWP, the second lens is E2, the diffractive optical element is DOE, the third lens is E3, the semi-transparent and semi-reflective film is BS, and the display screen is IMG. Each optical element is clearly labeled.

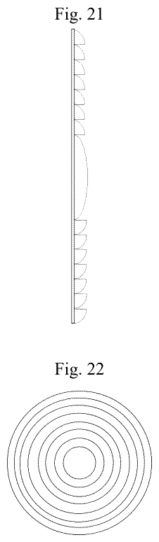

FIG. 21 and FIG. 22 show schematic diagrams of the diffractive optical element DOE. FIG. 21 is a schematic sectional view of the diffractive optical element. A right side in the figure, that is, a surface facing the third lens E3, is set as a diffractive optical surface. FIG. 22 is a front view of the diffractive optical surface.

Instances of particular surface types and parameters that may be applied to the VR eyepiece system of the above embodiment are further described below with reference to the drawings. It is to be noted that any one of the following Example 1 to Example 4 is applicable to all embodiments of the disclosure.

### Example 1

As shown in FIGS. 1 to 5, a VR eyepiece system according to Example 1 of the disclosure is described.

As shown in FIG. 1, the VR eyepiece system sequentially includes, from an eye-side surface of the VR eyepiece system to S14, an imaging surface of the VR eyepiece system: a first lens E1, a connecting assembly, a second lens E2, a diffractive optical element DOE, a third lens E3, a semi-transparent and semi-reflective film BS, and a display screen IMG. The first lens E1 and the second lens E2 are glued together through the connecting assembly. The connecting assembly sequentially includes, in a direction from the eye-side surface of the VR eyepiece system to S14, the imaging surface of the VR eyepiece system: a first glue layer, a linear polarizing plate LP, a second glue layer, a polarizing reflective film RP, a third glue layer, a quarter-wave plate QWP, and a fourth glue layer. The diffractive optical element DOE is closely fitted to S10, an image-side surface of the second lens. A diffractive optical surface of the diffractive optical element DOE is arranged towards S12, an eye-side surface of the third lens. S13, an image-side surface of the third lens has a semi-transparent and semi-reflective film BS.

Light from the VR eyepiece system in an eye-side direction sequentially passes through the first lens E1, the connecting assembly, the second lens E2, the diffractive optical element DOE, and the third lens E3 and then reaches the semi-transparent and semi-reflective film BS. The light rays reflected by the semi-transparent and semi-reflective film BS pass through the third lens E3, the diffractive optical element DOE, and the second lens E2 again and reaches the connecting assembly. The light rays are reflected by the polarizing reflective film RP in the connecting assembly. Thus the light rays propagate towards the imaging surface of the VR eyepiece system again, sequentially passes through the second lens E2, the diffractive optical element DOE, and the third lens E3, then is transmitted by the semi-transparent and semi-reflective film BS, and reaches S14, the imaging surface of the VR eyepiece system.

It should be noted that since a polarization direction of the light rays changes by 90° after passing through the quarter-wave plate QWP twice in a reflex process, the light rays are transmitted when reaching the polarizing reflective film RP for the first time, pass through the quarter-wave plate QWP twice, and then are reflected when reaching the polarizing reflective film RP for the second time.

In the example, the first lens E1 has a negative refractive power, S1, an eye-side surface of the first lens is a convex surface, and S2, an image-side surface of the first lens is a concave surface. The second lens E2 has a positive refractive power, S9, an eye-side surface of the second lens is a convex surface, and S10, an image-side surface of the second lens is a planar surface. The third lens E3 has a negative refractive power, S12, an eye-side surface of the third lens is a convex surface, and S13, an image-side surface of the third lens is a planar surface.

Table 1 is a table of basic structural parameters of the VR eyepiece system of Example 1. The units of the radius of curvature, the thickness/distance, and the effective focal length are millimeter (mm). In Table 1, an arrangement order of surface numbers is an order in which light rays pass, and refraction/reflection is a refraction or reflection effect of the light rays passing through the surface this time.

| | Surface | Surface | Radius of | | Refractive | Abbe | Refraction | Effective | Conic |
|---|---|---|---|---|---|---|---|---|---|
| Component | number | type | curvature | Thickness | index | number | mode | radius | coefficient |
| Diaphragm | | Spherical | Infinity | 26.0000 | | | Refraction | 2.0000 | |
| (STO) | | | | | | | | | |
| First lens | S1 | Aspheric | 261.8608 | 4.3500 | 1.68 | 19.20 | Refraction | 16.1688 | 68.20 |
| (E1) | | | | | | | | | |
| First | S2 | Aspheric | 130.7597 | 0.0150 | 1.47 | 50.00 | Refraction | 24.0000 | 5.86 |
| glue layer | | | | | | | | | |
| Linear | S3 | Aspheric | 130.7597 | 0.0500 | 1.53 | 50.00 | Refraction | 24.0000 | 5.86 |
| polarizing | | | | | | | | | |
| plate (LP) | | | | | | | | | |
| Second | S4 | Aspheric | 130.7597 | 0.0150 | 1.47 | 50.00 | Refraction | 24.0000 | 5.86 |
| glue layer | | | | | | | | | |
| Polarizing | S5 | Aspheric | 130.7597 | 0.0580 | 1.62 | 50.00 | Refraction | 24.0000 | 5.86 |
| reflective | | | | | | | | | |
| film (RP) | | | | | | | | | |
| Third | S6 | Aspheric | 130.7597 | 0.0150 | 1.47 | 50.00 | Refraction | 24.0000 | 5.86 |
| glue layer | | | | | | | | | |
| Quarter-wave | S7 | Aspheric | 130.7597 | 0.0500 | 1.53 | 50.00 | Refraction | 24.0000 | 5.86 |
| plate (QWP) | | | | | | | | | |
| Fourth | S8 | Aspheric | 130.7597 | 0.0150 | 1.47 | 50.00 | Refraction | 24.0000 | 5.86 |
| glue layer | | | | | | | | | |
| Second lens | S9 | Aspheric | 130.7597 | 5.4500 | 1.55 | 56.29 | Refraction | 24.0000 | 5.86 |
| (E2) | | | | | | | | | |
| Diffractive | S10 | Spherical | Infinity | 0.0050 | 1.55 | 56.29 | Refraction | 24.0000 | |
| optical element | | | | | | | | | |
| (DOE) | | | | | | | | | |
| | S11 | Spherical | Infinity | 3.3900 | | | Refraction | 24.0000 | |
| Third lens | S12 | Aspheric | 45.7744 | 6.1000 | 1.55 | 56.29 | Refraction | 24.0000 | −5.00 |
| (E3) | | | | | | | | | |
| Semi-transparent | S13 | Aspheric | −226.1892 | −6.1000 | 1.55 | 56.29 | Reflection | 24.0000 | 17.01 |
| and | | | | | | | | | |
| semi-reflective | | | | | | | | | |
| film (BS) | | | | | | | | | |
| Third lens | S12 | Aspheric | 45.7744 | −3.3900 | | | Refraction | 24.0000 | −5.00 |
| (E3) | | | | | | | | | |
| | S11 | Spherical | Infinity | −0.0050 | 1.55 | 56.29 | Refraction | 24.0000 | |
| Diffractive | S10 | Spherical | Infinity | −5.4500 | 1.55 | 56.29 | Refraction | 24.0000 | |
| optical element | | | | | | | | | |
| (DOE) | | | | | | | | | |
| Second lens | S9 | Aspheric | 130.7597 | −0.0150 | 1.47 | 50.00 | Refraction | 24.0000 | 5.86 |
| (E2) | | | | | | | | | |
| Fourth | S8 | Aspheric | 130.7597 | −0.0500 | 1.53 | 50.00 | Refraction | 24.0000 | 5.86 |
| glue layer | | | | | | | | | |
| Quarter-wave | S7 | Aspheric | 130.7597 | −0.0150 | 1.47 | 50.00 | Refraction | 24.0000 | 5.86 |
| plate (QWP) | | | | | | | | | |
| Third | S6 | Aspheric | 130.7597 | 0.0150 | 1.47 | 50.00 | Reflection | 24.0000 | 5.86 |
| glue layer | | | | | | | | | |
| Quarter-wave | S7 | Aspheric | 130.7597 | 0.0500 | 1.53 | 50.00 | Refraction | 24.0000 | 5.86 |
| plate (QWP) | | | | | | | | | |
| Fourth | S8 | Aspheric | 130.7597 | 0.0150 | 1.47 | 50.00 | Refraction | 24.0000 | 5.86 |
| glue layer | | | | | | | | | |
| Second lens | S9 | Aspheric | 130.7597 | 5.4500 | 1.55 | 56.29 | Refraction | 24.0000 | 5.86 |
| (E2) | | | | | | | | | |
| Diffractive | S10 | Spherical | Infinity | 0.0050 | 1.55 | 56.29 | Refraction | 24.0000 | |
| optical element | | | | | | | | | |
| (DOE) | | | | | | | | | |
| | S11 | Spherical | Infinity | 3.3900 | | | Refraction | 24.0000 | |
| Third lens | S12 | Aspheric | 45.7744 | 6.1000 | 1.55 | 56.29 | Refraction | 24.0000 | −5.00 |
| (E3) | | | | | | | | | |
| | S13 | Aspheric | −226.1892 | 3.0000 | | | Refraction | 15.7275 | 17.01 |
| Display screen | S14 | Spherical | Infinity | 0 | | | Refraction | 10.8365 | |
| (IMG) | | | | | | | | | |

In the example, all of two side surfaces of the first lens E1, S9, the eye-side surface of the second lens, and two side surfaces of the third lens E3 are aspheric surfaces, and the surface type of each aspheric lens may be defined by the following aspheric formula, which is not restrictive.

$$x = \frac{c {h}^{2}}{1 + \sqrt{1 - ( k + 1 ) {c}^{2} {h}^{2}}} + \sum A i {h}^{i} ; \qquad Formula ( 1 )$$

In the above formula, x is a vector height of a distance between the aspheric surface and a vertex of the aspheric surface when the aspheric surface is located at a position with the height h in the optical axis direction; c is a paraxial curvature of the aspheric surface, c=1/R, that is, the paraxial curvature c is an inverse of radius of curvature R in Table 1 above; k is a cone coefficient; and Ai is a correction coefficient of the i-th order of the aspheric surface. Table 2 below shows higher order term coefficients A2, A4, A6, A8, and A10 that may be used for each of the aspheric surfaces in the example.

TABLE 2

| Surface number | A2 | A4 | A6 | A8 | A10 |
|---|---|---|---|---|---|
| S1 | −3.61E−06 | 5.35E−08 | −3.18E−10 | 4.50E−13 | 0.00E+00 |
| S2 | 1.31E−06 | −5.56E−09 | 1.33E−11 | −8.56E−15 | −3.79E−18 |
| S3 | 1.31E−06 | −5.56E−09 | 1.33E−11 | −8.56E−15 | −3.79E−18 |
| S4 | 1.31E−06 | −5.56E−09 | 1.33E−11 | −8.56E−15 | −3.79E−18 |
| S5 | 1.31E−06 | −5.56E−09 | 1.33E−11 | −8.56E−15 | −3.79E−18 |
| S6 | 1.31E−06 | −5.56E−09 | 1.33E−11 | −8.56E−15 | −3.79E−18 |
| S7 | 1.31E−06 | −5.56E−09 | 1.33E−11 | −8.56E−15 | −3.79E−18 |
| S8 | 1.31E−06 | −5.56E−09 | 1.33E−11 | −8.56E−15 | −3.79E−18 |
| S9 | 1.31E−06 | −5.56E−09 | 1.33E−11 | −8.56E−15 | −3.79E−18 |
| S12 | −7.52E−06 | −4.54E−09 | 0.00E+00 | 0.00E+00 | 0.00E+00 |
| S13 | −2.18E−07 | −5.80E−09 | 1.87E−11 | −2.46E−14 | 9.72E−18 |

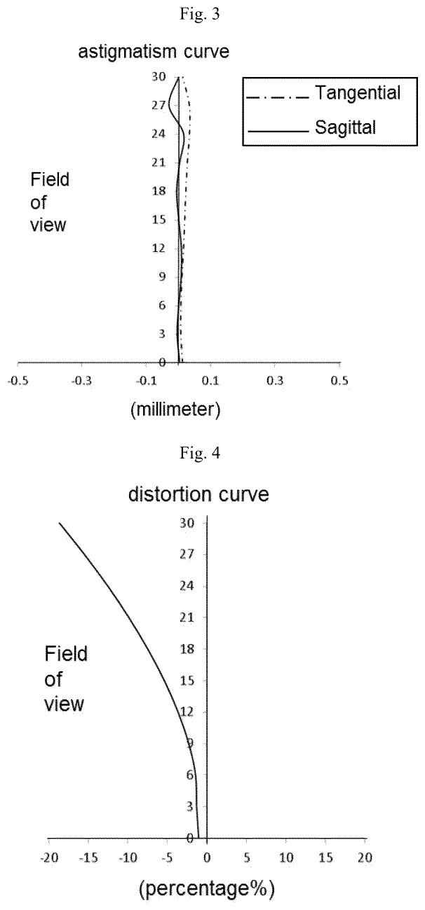

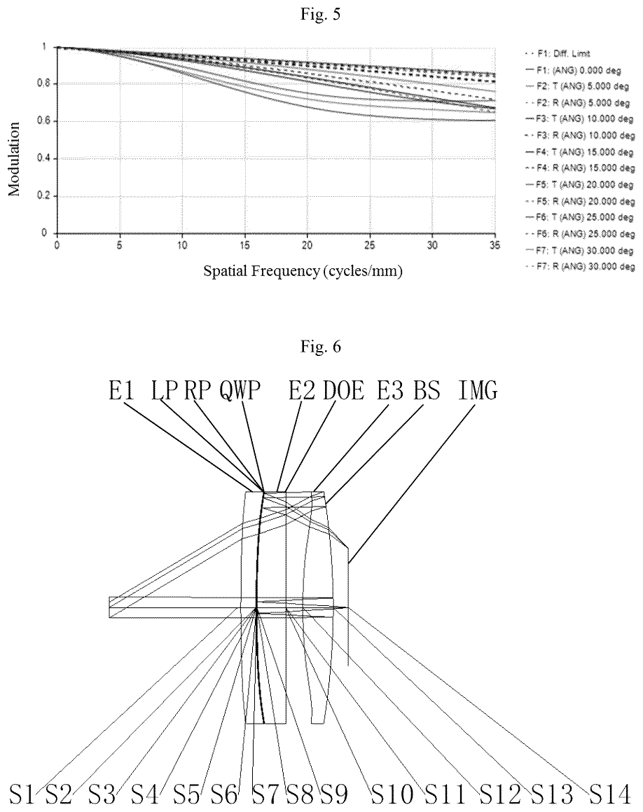

FIG. 2 illustrates a longitudinal aberration curve of the VR eyepiece system in Example 1, which shows that a convergence focus of light rays of different wavelengths is deviated after the light rays pass. FIG. 3 illustrates an astigmatism curve of the VR eyepiece system in Example 1, which shows a curvature of tangential image surface and a curvature of sagittal image surface. FIG. 4 illustrates a distortion curve of the VR eyepiece system in Example 1, which shows distortion magnitude values corresponding to different fields of view. FIG. 5 illustrates a modulation transfer function (MTF) curve of the VR eyepiece system according to Example 1. An on-axis MTF value is higher, which indicates that the imaging quality is desirable.

FIGS. 2 to 5 illustrate that the VR eyepiece system provided in Example 1 may achieve desirable imaging quality.

### Example 2

As shown in FIGS. 6 to 10, a VR eyepiece system according to Example 2 of the disclosure is described. A difference from Example 1 lies that the structural parameters of the VR eyepiece system are different. Parts of the description similar to Example 1 will be omitted for the sake of brevity.

As shown in FIG. 6, the VR eyepiece system sequentially includes, from an eye-side surface of the VR eyepiece system to S14, an imaging surface of the VR eyepiece system: a first lens E1, a connecting assembly, a second lens E2, a diffractive optical element DOE, a third lens E3, a semi-transparent and semi-reflective film BS, and a display screen IMG. The first lens E1 and the second lens E2 are glued together through the connecting assembly. The connecting assembly sequentially includes, in a direction from the eye-side surface of the VR eyepiece system to S14, the imaging surface of the VR eyepiece system: a first glue layer, a linear polarizing plate LP, a second glue layer, a polarizing reflective film RP, a third glue layer, a quarter-wave plate QWP, and a fourth glue layer. The diffractive optical element DOE is closely fitted to S10, an image-side surface of the second lens. A diffractive optical surface of the diffractive optical element DOE is arranged towards S12, an eye-side surface of the third lens. S13, an image-side surface of the third lens has a semi-transparent and semi-reflective film BS.

In the example, the first lens E1 has a negative refractive power, S1, an eye-side surface of the first lens is a convex surface, and S2, an image-side surface of the first lens is a concave surface. The second lens E2 has a positive refractive power, S9, an eye-side surface of the second lens is a convex surface, and S10, an image-side surface of the second lens is a planar surface. The third lens E3 has a negative refractive power, S12, an eye-side surface of the third lens is a convex surface, and S13, an image-side surface of the third lens is a planar surface.

Table 3 is a table of basic structural parameters of the VR eyepiece system of Example 2. The units of the radius of curvature, the thickness/distance, and the effective focal length are millimeter (mm). In Table 3, an arrangement order of surface numbers is an order in which light rays pass, and refraction/reflection is a refraction or reflection effect of the light rays passing through the surface this time.

TABLE 3

| | Surface | Surface | Radius of | | Refractive | Abbe | Refraction | Effective | Conic |
|---|---|---|---|---|---|---|---|---|---|
| Component | number | type | curvature | Thickness | index | number | mode | radius | coefficient |
| Diaphragm | | Spherical | Infinity | 26.0000 | | | Refraction | 2.0000 | |
| (STO) | | | | | | | | | |
| First lens (E1) | S1 | Aspheric | 303.1800 | 3.0000 | 1.68 | 19.20 | Refraction | 16.2210 | −1698.26 |
| First | S2 | Aspheric | 223.7024 | 0.0150 | 1.47 | 50.00 | Refraction | 24.0000 | 19.02 |
| glue layer | | | | | | | | | |
| Linear | S3 | Aspheric | 223.7024 | 0.0500 | 1.53 | 50.00 | Refraction | 24.0000 | 19.02 |
| polarizing | | | | | | | | | |
| plate (LP) | | | | | | | | | |
| Second | S4 | Aspheric | 223.7024 | 0.0150 | 1.47 | 50.00 | Refraction | 24.0000 | 19.02 |
| glue layer | | | | | | | | | |
| Polarizing | S5 | Aspheric | 223.7024 | 0.0580 | 1.62 | 50.00 | Refraction | 24.0000 | 19.02 |
| reflective film | | | | | | | | | |
| (RP) | | | | | | | | | |
| Third | S6 | Aspheric | 223.7024 | 0.0150 | 1.47 | 50.00 | Refraction | 24.0000 | 19.02 |
| glue layer | | | | | | | | | |
| Quarter-wave | S7 | Aspheric | 223.7024 | 0.0500 | 1.53 | 50.00 | Refraction | 24.0000 | 19.02 |
| plate (QWP) | | | | | | | | | |
| Fourth | S8 | Aspheric | 223.7024 | 0.0150 | 1.47 | 50.00 | Refraction | 24.0000 | 19.02 |
| glue layer | | | | | | | | | |
| Second lens | S9 | Aspheric | 223.7024 | 5.6818 | 1.55 | 56.29 | Refraction | 24.0000 | 19.02 |
| (E2) | | | | | | | | | |
| Diffractive | S10 | Spherical | Infinity | 0.0050 | 1.55 | 56.29 | Refraction | 24.0000 | |
| optical element | | | | | | | | | |
| (DOE) | | | | | | | | | |
| | S11 | Spherical | Infinity | 3.3900 | | | Refraction | 24.0000 | |
| Third lens | S12 | Aspheric | 118.5507 | 6.0000 | 1.55 | 56.29 | Refraction | 24.0000 | 21.62 |
| (E3) | | | | | | | | | |
| Semi-transparent | S13 | Aspheric | −118.5507 | −6.0000 | 1.55 | 56.29 | Reflection | 24.0000 | 21.62 |
| and | | | | | | | | | |
| semi-reflective | | | | | | | | | |
| film (BS) | | | | | | | | | |
| Third lens | S12 | Aspheric | 118.5507 | −3.3900 | | | Refraction | 24.0000 | 21.62 |
| (E3) | | | | | | | | | |
| | S11 | Spherical | Infinity | −0.0050 | 1.55 | 56.29 | Refraction | 24.0000 | |
| Diffractive | S10 | Spherical | Infinity | −5.6818 | 1.55 | 56.29 | Refraction | 24.0000 | |
| optical element | | | | | | | | | |
| (DOE) | | | | | | | | | |
| Second lens | S9 | Aspheric | 223.7024 | −0.0150 | 1.47 | 50.00 | Refraction | 24.0000 | 19.02 |
| (E2) | | | | | | | | | |
| Fourth | S8 | Aspheric | 223.7024 | −0.0500 | 1.53 | 50.00 | Refraction | 24.0000 | 19.02 |
| glue layer | | | | | | | | | |
| Quarter-wave | S7 | Aspheric | 223.7024 | −0.0150 | 1.47 | 50.00 | Refraction | 24.0000 | 19.02 |
| plate (QWP) | | | | | | | | | |
| Third | S6 | Aspheric | 223.7024 | 0.0150 | 1.47 | 50.00 | Reflection | 24.0000 | 19.02 |
| glue layer | | | | | | | | | |
| Quarter-wave | S7 | Aspheric | 223.7024 | 0.0500 | 1.53 | 50.00 | Refraction | 24.0000 | 19.02 |
| plate (QWP) | | | | | | | | | |
| Fourth | S8 | Aspheric | 223.7024 | 0.0150 | 1.47 | 50.00 | Refraction | 24.0000 | 19.02 |
| glue layer | | | | | | | | | |
| Second lens | S9 | Aspheric | 223.7024 | 5.6818 | 1.55 | 56.29 | Refraction | 24.0000 | 19.02 |
| (E2) | | | | | | | | | |
| Diffractive | S10 | Spherical | Infinity | 0.0050 | 1.55 | 56.29 | Refraction | 24.0000 | |
| optical element | | | | | | | | | |
| (DOE) | | | | | | | | | |
| | S11 | Spherical | Infinity | 3.3900 | | | Refraction | 24.0000 | |
| Third lens (E3) | S12 | Aspheric | 118.5507 | 6.0000 | 1.55 | 56.29 | Refraction | 24.0000 | 21.62 |
| | S13 | Aspheric | −118.5507 | 3.0000 | | | Refraction | 15.4013 | 21.62 |
| Display screen | S14 | Spherical | Infinity | 0 | | | Refraction | 11.3636 | |
| (IMG) | | | | | | | | | |

In the example, all of two side surfaces of the first lens E1, S9, the eye-side surface of the second lens, and two side surfaces of the third lens E3 are aspheric surfaces, and the surface type of each aspheric lens may be defined by formula (1) in Example 1, which is not restrictive. Table 4 below shows higher order term coefficients that may be used for each of the aspheric surfaces in the example.

TABLE 4

| Surface number | A2 | A4 | A6 | A8 | A10 |
|---|---|---|---|---|---|
| S1 | 3.22E−06 | −6.20E−09 | −8.22E−13 | 4.42E−14 | −4.29E−17 |
| S2 | −1.04E−07 | 6.91E−09 | −2.05E−11 | 4.33E−14 | −3.66E−17 |
| S3 | −1.04E−07 | 6.91E−09 | −2.05E−11 | 4.33E−14 | −3.66E−17 |
| S4 | −1.04E−07 | 6.91E−09 | −2.05E−11 | 4.33E−14 | −3.66E−17 |
| S5 | −1.04E−07 | 6.91E−09 | −2.05E−11 | 4.33E−14 | −3.66E−17 |
| S6 | −1.04E−07 | 6.91E−09 | −2.05E−11 | 4.33E−14 | −3.66E−17 |
| S7 | −1.04E−07 | 6.91E−09 | −2.05E−11 | 4.33E−14 | −3.66E−17 |
| S8 | −1.04E−07 | 6.91E−09 | −2.05E−11 | 4.33E−14 | −3.66E−17 |
| S9 | −1.04E−07 | 6.91E−09 | −2.05E−11 | 4.33E−14 | −3.66E−17 |
| S12 | 9.02E−06 | −2.86E−08 | 3.14E−11 | −1.11E−13 | 9.67E−17 |
| S13 | 3.21E−06 | 2.91E−09 | −1.13E−12 | −2.07E−14 | 3.78E−17 |

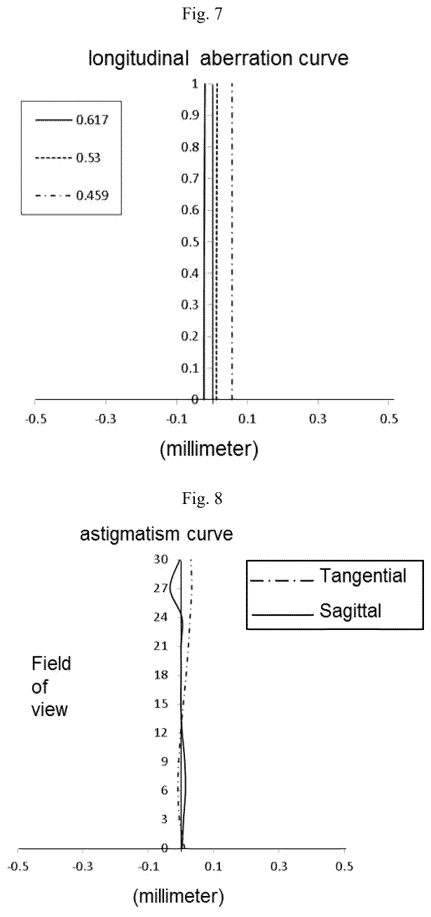

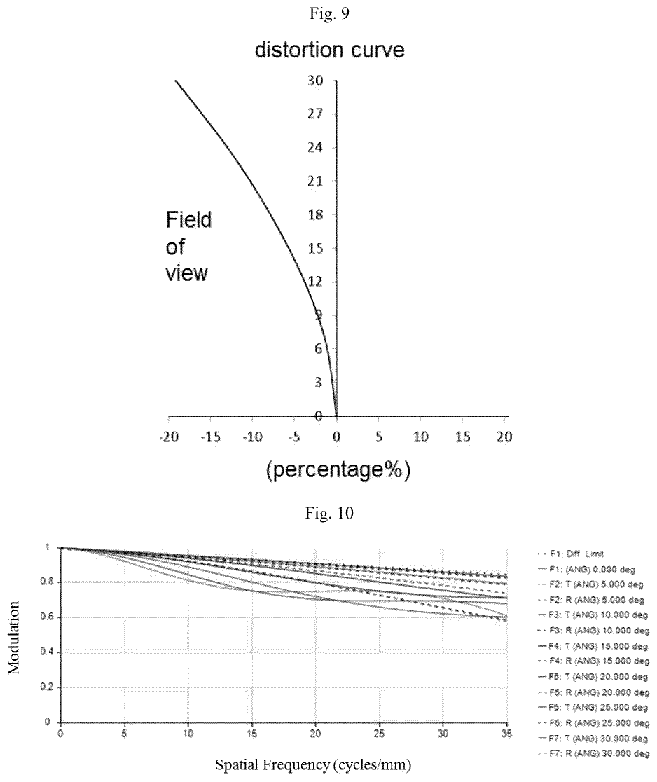

FIG. 7 illustrates a longitudinal aberration curve of the VR eyepiece system in Example 2, which shows that a convergence focus of light rays of different wavelengths is deviated after the light rays pass. FIG. 8 illustrates an astigmatism curve of the VR eyepiece system in Example 2, which shows a curvature of tangential image surface and a curvature of sagittal image surface. FIG. 9 illustrates a distortion curve of the VR eyepiece system in Example 2, which shows distortion magnitude values corresponding to different fields of view. FIG. 10 illustrates a modulation transfer function (MTF) curve of the VR eyepiece system according to Example 2. An on-axis MTF value is higher, which indicates that the imaging quality is desirable.

FIGS. 7 to 10 illustrate that the VR eyepiece system provided in Example 2 may achieve desirable imaging quality.

### Example 3

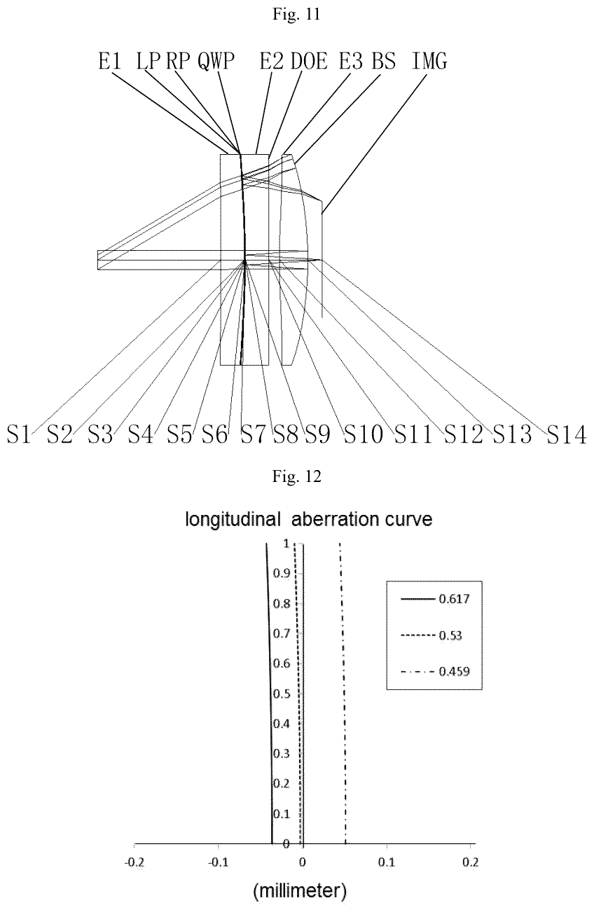

As shown in FIGS. 11 to 15, a VR eyepiece system according to Example 3 of the disclosure is described. A difference from Example 1 lies that the structural parameters are different.

As shown in FIG. 11, the VR eyepiece system sequentially includes, from an eye-side surface of the VR eyepiece system to S14, an imaging surface of the VR eyepiece system: a first lens E1, a connecting assembly, a second lens E2, a diffractive optical element DOE, a third lens E3, a semi-transparent and semi-reflective film BS, and a display screen IMG. The first lens E1 and the second lens E2 are glued together through the connecting assembly. The connecting assembly sequentially includes, in a direction from the eye-side surface of the VR eyepiece system to S14, the imaging surface of the VR eyepiece system: a first glue layer, a linear polarizing plate LP, a second glue layer, a polarizing reflective film RP, a third glue layer, a quarter-wave plate QWP, and a fourth glue layer. The diffractive optical element DOE is closely fitted to S10, an image-side surface of the second lens. A diffractive optical surface of the diffractive optical element DOE is arranged towards S12, an eye-side surface of the third lens. S13, an image-side surface of the third lens has a semi-transparent and semi-reflective film BS.

In the example, the first lens E1 has a positive refractive power, S1, an eye-side surface of the first lens is a concave surface, and S2, an image-side surface of the first lens is a convex surface. The second lens E2 has a positive refractive power, S9, an eye-side surface of the second lens is a concave surface, and S10, an image-side surface of the second lens is a planar surface. The third lens E3 has a negative refractive power, S12, an eye-side surface of the third lens is a convex surface, and S13, an image-side surface of the third lens is a planar surface.

Table 5 is a table of basic structural parameters of the VR eyepiece system of Example 3. The units of the radius of curvature, the thickness/distance, and the effective focal length are millimeter (mm). In Table 5, an arrangement order of surface numbers is an order in which light rays pass, and refraction/reflection is a refraction or reflection effect of the light rays passing through the surface this time.

TABLE 5

| | Surface | Surface | Radius of | | Refractive | Abbe | Refraction | Effective | Conic |
|---|---|---|---|---|---|---|---|---|---|
| Component | number | type | curvature | Thickness | index | number | mode | radius | coefficient |
| Diaphragm | | Spherical | Infinity | 26.0000 | | | Refraction | 2.0000 | |
| (STO) | | | | | | | | | |
| First lens | S1 | Aspheric | −2239.9560 | 5.0000 | 1.68 | 19.20 | Refraction | 15.9477 | −200.00 |
| (E1) | | | | | | | | | |
| First | S2 | Aspheric | −194.3684 | 0.0150 | 1.47 | 50.00 | Refraction | 24.0000 | −200.00 |
| glue layer | | | | | | | | | |
| Linear | S3 | Aspheric | −194.3684 | 0.0500 | 1.53 | 50.00 | Refraction | 24.0000 | −200.00 |
| polarizing | | | | | | | | | |
| plate (LP) | | | | | | | | | |
| Second | S4 | Aspheric | −194.3684 | 0.0150 | 1.47 | 50.00 | Refraction | 24.0000 | −200.00 |
| glue layer | | | | | | | | | |
| Polarizing | S5 | Aspheric | −194.3684 | 0.0580 | 1.62 | 50.00 | Refraction | 24.0000 | −200.00 |
| reflective film | | | | | | | | | |
| (RP) | | | | | | | | | |
| Third | S6 | Aspheric | −194.3684 | 0.0150 | 1.47 | 50.00 | Refraction | 24.0000 | −200.00 |
| glue layer | | | | | | | | | |
| Quarter-wave | S7 | Aspheric | −194.3684 | 0.0500 | 1.53 | 50.00 | Refraction | 24.0000 | −200.00 |
| plate (QWP) | | | | | | | | | |
| Fourth | S8 | Aspheric | −194.3684 | 0.0150 | 1.47 | 50.00 | Refraction | 24.0000 | −200.00 |
| glue layer | | | | | | | | | |
| Second lens | S9 | Aspheric | −194.3684 | 5.0000 | 1.55 | 56.29 | Refraction | 24.0000 | −200.00 |
| (E2) | | | | | | | | | |
| Diffractive | S10 | Spherical | Infinity | 0.0050 | 1.55 | 56.29 | Refraction | 24.0000 | |
| optical element | | | | | | | | | |
| (DOE) | | | | | | | | | |
| | S11 | Spherical | Infinity | 2.1799 | | | Refraction | 24.0000 | |
| Third lens | S12 | Aspheric | 151.4421 | 6.0000 | 1.55 | 56.29 | Refraction | 24.0000 | −1.46 |
| (E3) | | | | | | | | | |
| Semi- | S13 | Aspheric | −74.3657 | −6.0000 | 1.55 | 56.29 | Reflection | 24.0000 | −12.81 |
| transparent | | | | | | | | | |
| and | | | | | | | | | |
| semi-reflective | | | | | | | | | |
| film (BS) | | | | | | | | | |
| Third lens | S12 | Aspheric | 151.4421 | −2.1799 | | | Refraction | 24.0000 | −1.46 |
| (E3) | | | | | | | | | |
| | S11 | Spherical | Infinity | −0.0050 | 1.55 | 56.29 | Refraction | 24.0000 | |
| Diffractive | S10 | Spherical | Infinity | −5.0000 | 1.55 | 56.29 | Refraction | 24.0000 | |
| optical element | | | | | | | | | |
| (DOE) | | | | | | | | | |
| Second lens | S9 | Aspheric | −194.3684 | −0.0150 | 1.47 | 50.00 | Refraction | 24.0000 | −200.00 |
| (E2) | | | | | | | | | |
| Fourth | S8 | Aspheric | −194.3684 | −0.0500 | 1.53 | 50.00 | Refraction | 24.0000 | −200.00 |
| glue layer | | | | | | | | | |
| Quarter-wave | S7 | Aspheric | −194.3684 | −0.0150 | 1.47 | 50.00 | Refraction | 24.0000 | −200.00 |
| plate (QWP) | | | | | | | | | |
| Third | S6 | Aspheric | −194.3684 | 0.0150 | 1.47 | 50.00 | Reflection | 24.0000 | −200.00 |
| glue layer | | | | | | | | | |
| Quarter-wave | S7 | Aspheric | −194.3684 | 0.0500 | 1.53 | 50.00 | Refraction | 24.0000 | −200.00 |
| plate (QWP) | | | | | | | | | |
| Fourth | S8 | Aspheric | −194.3684 | 0.0150 | 1.47 | 50.00 | Refraction | 24.0000 | −200.00 |
| glue layer | | | | | | | | | |
| Second lens | S9 | Aspheric | −194.3684 | 5.0000 | 1.55 | 56.29 | Refraction | 24.0000 | −200.00 |
| (E2) | | | | | | | | | |
| Diffractive | S10 | Spherical | Infinity | 0.0050 | 1.55 | 56.29 | Refraction | 24.0000 | |
| optical element | | | | | | | | | |
| (DOE) | | | | | | | | | |
| | S11 | Spherical | Infinity | 2.1799 | | | Refraction | 24.0000 | |
| Third lens | S12 | Aspheric | 151.4421 | 6.0000 | 1.55 | 56.29 | Refraction | 24.0000 | −1.46 |
| (E3) | | | | | | | | | |
| | S13 | Aspheric | −74.3657 | 3.0000 | | | Refraction | 14.3320 | −12.81 |
| Display screen | S14 | Spherical | Infinity | 0.0000 | | | Refraction | 12.0590 | |
| (IMG) | | | | | | | | | |

In the example, all of two side surfaces of the first lens E1, S9, the eye-side surface of the second lens, and two side surfaces of the third lens E3 are aspheric surfaces, and the surface type of each aspheric lens may be defined by formula (1) in Example 1, which is not restrictive. Table 6 below shows higher order term coefficients that may be used for each of the aspheric surfaces in the example.

TABLE 6

| Surface | | | | | | | | | |
|---|---|---|---|---|---|---|---|---|---|
| number | A2 | A4 | A6 | A8 | A10 | A12 | A14 | A16 | A18 |
| S1 | 3.91E−06 | −1.15E−08 | −3.38E−11 | −4.67E−14 | −4.67E−14 | 4.06E−16 | 0.00E+00 | 0.00E+00 | 0.00E+00 |
| S2 | −9.53E−07 | 8.16E−10 | 4.81E−14 | −1.15E−15 | 4.95E−19 | 0.00E+00 | 0.00E+00 | 0.00E+00 | 0.00E+00 |
| S3 | −9.53E−07 | 8.16E−10 | 4.81E−14 | −1.15E−15 | 4.95E−19 | 0.00E+00 | 0.00E+00 | 0.00E+00 | 0.00E+00 |
| S4 | −9.53E−07 | 8.16E−10 | 4.81E−14 | −1.15E−15 | 4.95E−19 | 0.00E+00 | 0.00E+00 | 0.00E+00 | 0.00E+00 |
| S5 | −9.53E−07 | 8.16E−10 | 4.81E−14 | −1.15E−15 | 4.95E−19 | 0.00E+00 | 0.00E+00 | 0.00E+00 | 0.00E+00 |
| S6 | −9.53E−07 | 8.16E−10 | 4.81E−14 | −1.15E−15 | 4.95E−19 | 0.00E+00 | 0.00E+00 | 0.00E+00 | 0.00E+00 |
| S7 | −9.53E−07 | 8.16E−10 | 4.81E−14 | −1.15E−15 | 4.95E−19 | 0.00E+00 | 0.00E+00 | 0.00E+00 | 0.00E+00 |
| S8 | −9.53E−07 | 8.16E−10 | 4.81E−14 | −1.15E−15 | 4.95E−19 | 0.00E+00 | 0.00E+00 | 0.00E+00 | 0.00E+00 |
| S9 | −9.53E−07 | 8.16E−10 | 4.81E−14 | −1.15E−15 | 4.95E−19 | 0.00E+00 | 0.00E+00 | 0.00E+00 | 0.00E+00 |
| S12 | −4.66E−06 | −5.05E−09 | 1.75E−11 | −1.35E−14 | −4.53E−18 | 0.00E+00 | 0.00E+00 | 0.00E+00 | 0.00E+00 |
| S13 | −3.46E−06 | −4.08E−10 | 1.46E−12 | −6.35E−15 | 2.00E−17 | −6.16E−20 | 7.30E−23 | −9.14E−27 | 0.00E+00 |

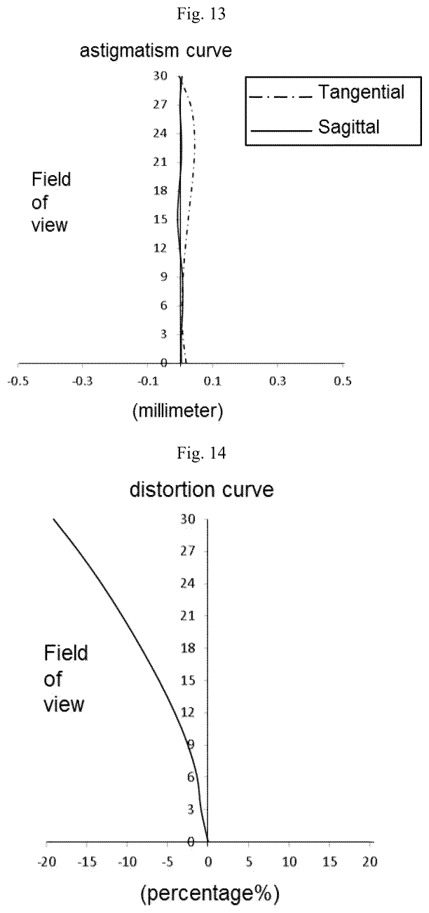

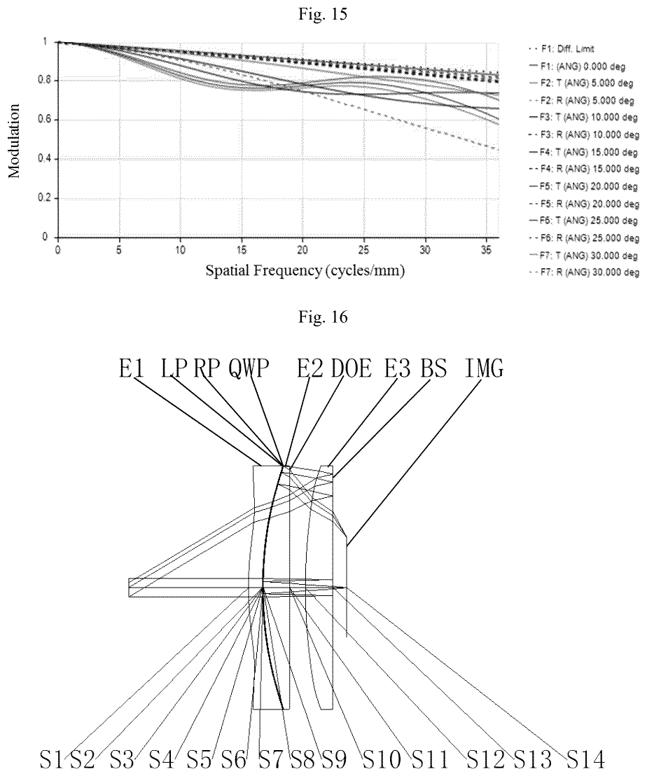

FIG. 12 illustrates a longitudinal aberration curve of the VR eyepiece system in Example 3, which shows that a convergence focus of light rays of different wavelengths is deviated after the light rays pass. FIG. 13 illustrates an astigmatism curve of the VR eyepiece system in Example 3, which shows a curvature of tangential image surface and a curvature of sagittal image surface. FIG. 14 illustrates a distortion curve of the VR eyepiece system in Example 3, which shows distortion magnitude values corresponding to different fields of view. FIG. 15 illustrates a modulation transfer function (MTF) curve of the VR eyepiece system according to Example 3. An on-axis MTF value is higher, which indicates that the imaging quality is desirable.

FIGS. 12 to 15 illustrate that the VR eyepiece system provided in Example 3 may achieve desirable imaging quality.

### Example 4

As shown in FIG. 16 to FIG. 20, a VR eyepiece system according to Example 4 of the disclosure is described. A difference from Example 1 lies that the structural parameters are different.

As shown in FIG. 16, the VR eyepiece system sequentially includes, from an eye-side surface of the VR eyepiece system to S14, an imaging surface of the VR eyepiece system: a first lens E1, a connecting assembly, a second lens E2, a diffractive optical element DOE, a third lens E3, a semi-transparent and semi-reflective film BS, and a display screen IMG. The first lens E1 and the second lens E2 are glued together through the connecting assembly. The connecting assembly sequentially includes, in a direction from the eye-side surface of the VR eyepiece system to S14, the imaging surface of the VR eyepiece system: a first glue layer, a linear polarizing plate LP, a second glue layer, a polarizing reflective film RP, a third glue layer, a quarter-wave plate QWP, and a fourth glue layer. The diffractive optical element DOE is closely fitted to S10, an image-side surface of the second lens. A diffractive optical surface of the diffractive optical element DOE is arranged towards S12, an eye-side surface of the third lens. S13, an image-side surface of the third lens has a semi-transparent and semi-reflective film BS.

In the example, the first lens E1 has a positive refractive power, S1, an eye-side surface of the first lens is a convex surface, and S2, an image-side surface of the first lens is a concave surface. The second lens E2 has a positive refractive power, S9, an eye-side surface of the second lens is a convex surface, and S10, an image-side surface of the second lens is a planar surface. The third lens E3 has a negative refractive power, S12, an eye-side surface of the third lens is a convex surface, and S13, an image-side surface of the third lens is a planar surface.

Table 7 is a table of basic structural parameters of the VR eyepiece system of Example 4, where the units of the radius of curvature, the thickness/distance, and the effective focal length are millimeters (mm). In Table 7, an arrangement order of surface numbers is an order in which light rays pass, and refraction/reflection is a refraction or reflection effect of the light rays passing through the surface this time.

TABLE 7

| | Surface | Surface | Radius of | | Refractive | Abbe | Refraction | Effective | Conic |
|---|---|---|---|---|---|---|---|---|---|
| Component | number | type | curvature | Thickness | index | number | mode | radius | coefficient |
| Diaphragm | | Spherical | Infinity | 26.0000 | | | Refraction | 2.0000 | |
| (STO) | | | | | | | | | |
| First lens | S1 | Aspheric | 65.9878 | 3.0000 | 1.68 | 19.20 | Refraction | 16.7344 | −83.85 |
| (E1) | | | | | | | | | |
| First | S2 | Aspheric | 74.5302 | 0.0150 | 1.47 | 50.00 | Refraction | 24.0000 | 0.33 |
| glue layer | | | | | | | | | |
| Linear polarizing | S3 | Aspheric | 74.5302 | 0.0500 | 1.53 | 50.00 | Refraction | 24.0000 | 0.33 |
| plate (LP) | | | | | | | | | |
| Second | S4 | Aspheric | 74.5302 | 0.0150 | 1.47 | 50.00 | Refraction | 24.0000 | 0.33 |
| glue layer | | | | | | | | | |
| Polarizing | S5 | Aspheric | 74.5302 | 0.0580 | 1.62 | 50.00 | Refraction | 24.0000 | 0.33 |
| reflective film | | | | | | | | | |
| (RP) | | | | | | | | | |
| Third | S6 | Aspheric | 74.5302 | 0.0150 | 1.47 | 50.00 | Refraction | 24.0000 | 0.33 |
| glue layer | | | | | | | | | |
| Quarter-wave | S7 | Aspheric | 74.5302 | 0.0500 | 1.53 | 50.00 | Refraction | 24.0000 | 0.33 |
| plate (QWP) | | | | | | | | | |
| Fourth | S8 | Aspheric | 74.5302 | 0.0150 | 1.47 | 50.00 | Refraction | 24.0000 | 0.33 |
| glue layer | | | | | | | | | |
| Second lens | S9 | Aspheric | 74.5302 | 5.6818 | 1.55 | 56.29 | Refraction | 24.0000 | 0.33 |
| (E2) | | | | | | | | | |
| Diffractive | S10 | Spherical | Infinity | 0.0050 | 1.55 | 56.29 | Refraction | 24.0000 | |
| optical element | | | | | | | | | |
| (DOE) | | | | | | | | | |
| | S11 | Spherical | Infinity | 3.3900 | | | Refraction | 24.0000 | |
| Third lens | S12 | Aspheric | 115.2032 | 6.0000 | 1.55 | 56.29 | Refraction | 24.0000 | 9.38 |
| (E3) | | | | | | | | | |
| Semi-transparent | S13 | Spherical | Infinity | −6.0000 | 1.55 | 56.29 | Reflection | 24.0000 | |
| and | | | | | | | | | |
| semi-reflective | | | | | | | | | |
| film (BS) | | | | | | | | | |
| Third lens | S12 | Aspheric | 115.2032 | −3.3900 | | | Refraction | 24.0000 | 9.38 |
| (E3) | | | | | | | | | |
| | S11 | Spherical | Infinity | −0.0050 | 1.55 | 56.29 | Refraction | 24.0000 | |
| Diffractive | S10 | Spherical | Infinity | −5.6818 | 1.55 | 56.29 | Refraction | 24.0000 | |
| optical element | | | | | | | | | |
| (DOE) | | | | | | | | | |
| Second lens | S9 | Aspheric | 74.5302 | −0.0150 | 1.47 | 50.00 | Refraction | 24.0000 | 0.33 |
| (E2) | | | | | | | | | |
| Fourth | S8 | Aspheric | 74.5302 | −0.0500 | 1.53 | 50.00 | Refraction | 24.0000 | 0.33 |
| glue layer | | | | | | | | | |
| Quarter-wave | S7 | Aspheric | 74.5302 | −0.0150 | 1.47 | 50.00 | Refraction | 24.0000 | 0.33 |
| plate (QWP) | | | | | | | | | |
| Third | S6 | Aspheric | 74.5302 | 0.0150 | 1.47 | 50.00 | Reflection | 24.0000 | 0.33 |
| glue layer | | | | | | | | | |
| Quarter-wave | S7 | Aspheric | 74.5302 | 0.0500 | 1.53 | 50.00 | Refraction | 24.0000 | 0.33 |
| plate (QWP) | | | | | | | | | |
| Fourth | S8 | Aspheric | 74.5302 | 0.0150 | 1.47 | 50.00 | Refraction | 24.0000 | 0.33 |
| glue layer | | | | | | | | | |
| Second lens | S9 | Aspheric | 74.5302 | 5.6818 | 1.55 | 56.29 | Refraction | 24.0000 | 0.33 |
| (E2) | | | | | | | | | |
| Diffractive | S10 | Spherical | Infinity | 0.0050 | 1.55 | 56.29 | Refraction | 24.0000 | |
| optical element | | | | | | | | | |
| (DOE) | | | | | | | | | |
| | S11 | Spherical | Infinity | 3.3900 | | | Refraction | 24.0000 | |
| Third lens | S12 | Aspheric | 115.2032 | 6.0000 | 1.55 | 56.29 | Refraction | 24.0000 | 9.38 |
| (E3) | | | | | | | | | |
| | S13 | Spherical | Infinity | 3.0000 | | | Refraction | 15.8162 | |
| Display screen | S14 | Spherical | Infinity | 0.0000 | | | Refraction | 10.5409 | |
| (IMG) | | | | | | | | | |

In the example, all of two side surfaces of the first lens E1, S9, the eye-side surface of the second lens, and two side surfaces of the third lens E3 are aspheric surfaces, and the surface type of each aspheric lens may be defined by formula (1) in Example 1, which is not restrictive.

Table 8 below shows higher order term coefficients that may be used for each of the aspheric surfaces in the example.

TABLE 8

| Surface | | | | | | | | | |
|---|---|---|---|---|---|---|---|---|---|
| number | A2 | A4 | A6 | A8 | A10 | A12 | A14 | A16 | A18 |
| S1 | 1.83E−05 | −7.86E−08 | 1.92E−10 | −8.11E−13 | −8.11E−13 | 1.23E−15 | 0.00E+00 | 0.00E+00 | 0.00E+00 |
| S2 | −3.23E−06 | 1.62E−08 | −3.00E−11 | 2.15E−14 | −1.71E−18 | −6.73E−21 | 2.69E−24 | 0.00E+00 | 0.00E+00 |
| S3 | −3.23E−06 | 1.62E−08 | −3.00E−11 | 2.15E−14 | −1.71E−18 | −6.73E−21 | 2.69E−24 | 0.00E+00 | 0.00E+00 |
| S4 | −3.23E−06 | 1.62E−08 | −3.00E−11 | 2.15E−14 | −1.71E−18 | −6.73E−21 | 2.69E−24 | 0.00E+00 | 0.00E+00 |
| S5 | −3.23E−06 | 1.62E−08 | −3.00E−11 | 2.15E−14 | −1.71E−18 | −6.73E−21 | 2.69E−24 | 0.00E+00 | 0.00E+00 |
| S6 | −3.23E−06 | 1.62E−08 | −3.00E−11 | 2.15E−14 | −1.71E−18 | −6.73E−21 | 2.69E−24 | 0.00E+00 | 0.00E+00 |
| S7 | −3.23E−06 | 1.62E−08 | −3.00E−11 | 2.15E−14 | −1.71E−18 | −6.73E−21 | 2.69E−24 | 0.00E+00 | 0.00E+00 |
| S8 | −3.23E−06 | 1.62E−08 | −3.00E−11 | 2.15E−14 | −1.71E−18 | −6.73E−21 | 2.69E−24 | 0.00E+00 | 0.00E+00 |
| S9 | −3.23E−06 | 1.62E−08 | −3.00E−11 | 2.15E−14 | −1.71E−18 | −6.73E−21 | 2.69E−24 | 0.00E+00 | 0.00E+00 |
| S12 | 5.74E−06 | −9.90E−10 | −3.83E−12 | 2.10E−14 | −2.06E−17 | 0.00E+00 | 0.00E+00 | 0.00E+00 | 0.00E+00 |

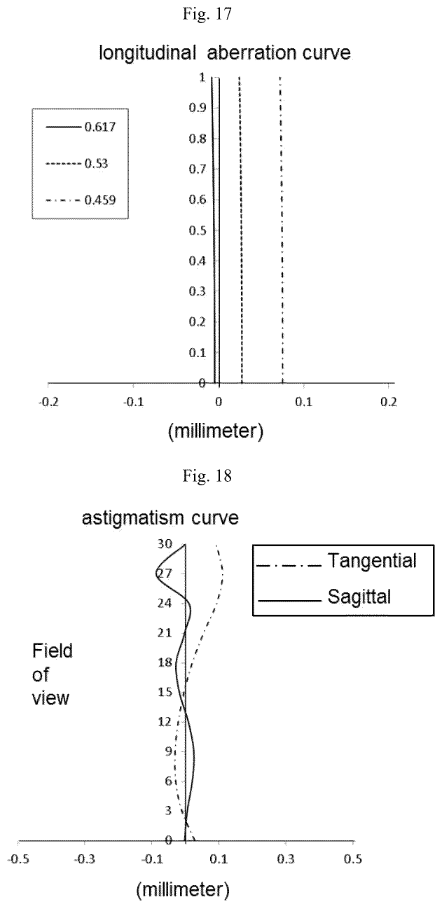

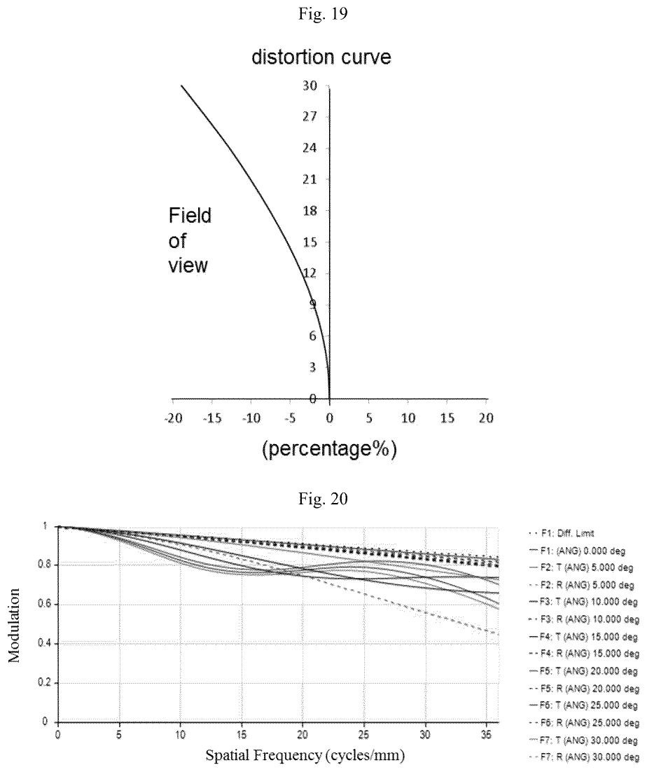

FIG. 17 illustrates a longitudinal aberration curve of the VR eyepiece system in Example 4, which shows that a convergence focus of light rays of different wavelengths is deviated after the light rays pass. FIG. 18 illustrates an astigmatism curve of the VR eyepiece system in Example 4, which shows a curvature of tangential image surface and a curvature of sagittal image surface. FIG. 19 illustrates a distortion curve of the VR eyepiece system in Example 4, which shows distortion magnitude values corresponding to different fields of view. FIG. 20 illustrates a modulation transfer function (MTF) curve of the VR eyepiece system according to Example 4. An on-axis MTF value is higher, which indicates that the imaging quality is desirable.

FIGS. 17 to 20 illustrate that the VR eyepiece system provided in Example 4 may achieve desirable imaging quality.

In summary, the VR eyepiece system of the disclosure has the above Examples 1 to 4, and the following Table 9 shows some optical parameters of the four examples.

TABLE 9

| | Example | | | |
|---|---|---|---|---|
| Example Parameter | 1 | 2 | 3 | 4 |
| TTL (mm) | 22.513 | 21.295 | 21.403 | 21.295 |
| ED (mm) | 26.000 | 26.000 | 26.000 | 26.000 |
| TD (mm) | 22.513 | 21.295 | 21.403 | 21.295 |
| ImgH (mm) | 10.806 | 11.359 | 12.053 | 10.541 |
| f (mm) | 21.671 | 23.546 | 23.557 | 20.933 |
| HFOV (°) | 30.000 | 30.000 | 30.000 | 30.000 |
| FNO | 5.576 | 6.022 | 5.985 | 5.393 |
| f1 (mm) | −390.940 | −1279.697 | 314.000 | 744.628 |
| f2 (mm) | 1106.035 | 1173.023 | 1813.543 | 664.374 |
| f3 (mm) | −61.933 | −51.152 | −34.661 | −325.978 |
| EPD (mm) | 3.887 | 3.910 | 3.936 | 3.882 |
| F1 (mm) | 641.327 | 588.668 | 963.106 | 157.761 |
| ET1 (mm) | 5.368 | 3.365 | 4.410 | 3.874 |
| ET2 (mm) | 4.107 | 4.908 | 5.669 | 3.492 |
| ET3 (mm) | 1.743 | 2.400 | 2.000 | 3.507 |

Table 10 shows conditional expression values of Examples 1 to 4.

TABLE 10

| | Example | | | |
|---|---|---|---|---|
| Conditional expression | 1 | 2 | 3 | 4 |
| f/(F1 − f3) | 0.031 | 0.037 | 0.024 | 0.043 |
| f3/F1 | −0.097 | −0.087 | −0.036 | −2.066 |
| Tr1r4/CT3 | 1.642 | 1.483 | 1.703 | 1.483 |
| ED/TTL | 1.155 | 1.221 | 1.215 | 1.221 |
| IMGH/EPD | 2.780 | 2.905 | 3.062 | 2.715 |
| f3/f | −2.858 | −2.172 | −1.471 | −15.572 |
| f2/f1 | −2.829 | −0.917 | 5.776 | 0.892 |
| TTL/f | 1.039 | 0.904 | 0.909 | 1.017 |
| (CT2*N2) − (CT1*N1) | 1.133 | 3.756 | −0.653 | 3.756 |
| (ET1 + ET2)/ET3 | 5.437 | 3.447 | 5.039 | 2.100 |
| R3/R5 | 2.857 | 1.887 | −1.283 | 0.647 |
| T23/TD | 0.174 | 0.188 | 0.121 | 0.185 |

Apparently, the examples described are merely some examples rather than all examples of the disclosure. Based on the examples of the disclosure, all other examples acquired by those of ordinary skill in the art without making creative efforts fall within the scope of protection of the disclosure.

It should be noted that the terms used herein are for the purpose of describing detailed embodiments merely and are not intended to limit the illustrative embodiments in accordance with the disclosure. As used herein, the singular is intended to include the plural unless the context clearly dictates. Furthermore, it is to be understood that the terms “include” and/or “comprise” used in this specification specify the presence of features, steps, works, devices, components, and/or their combinations.

It should be noted that the terms “first”, “second” and so forth in the specification and claims of the disclosure and in the above-mentioned drawings are used to distinguish between similar objects and not necessarily to describe a particular order or sequential order. It should be understood that the data used in this way may be interchanged where appropriate, such that the embodiments of the disclosure described herein are able to be implemented in other sequences than those illustrated or described herein.

The foregoing is merely the preferred examples of the disclosure and is not intended to be limiting of the present invention, and various changes and modifications may be made by those skilled in the art. Any modifications, equivalent substitutions, improvements, etc. made within the spirit and scope of the disclosure should be included within the protection scope of the disclosure.

What is claimed is:

1. A virtual reality (VR) eyepiece system, sequentially comprising, from an eye-side surface of the VR eyepiece system to an imaging surface of the VR eyepiece system:
a first lens;
a connecting assembly, wherein the connecting assembly sequentially comprises, from the eye-side surface of the VR eyepiece system to the imaging surface of the VR eyepiece system: a first glue layer, a linear polarizing plate, a second glue layer, a polarizing reflective film, a third glue layer, a quarter-wave plate and a fourth glue layer;
a second lens, wherein the first lens and the second lens are glued together through the connecting assembly, the second lens has a positive refractive power, and an image-side surface of the second lens is a planar surface;
a diffractive optical element, wherein the diffractive optical element is closely fitted to the image-side surface of the second lens, the diffractive optical element has a diffractive optical surface, and the diffractive optical surface is of a planar structure with a preset thickness;
a third lens, wherein the third lens has a negative refractive power, an eye-side surface of the third lens is a convex surface, an image-side surface of the third lens has a semi-transparent and semi-reflective film, and the diffractive optical surface faces the eye-side surface of the third lens; and
a display screen, wherein the display screen is located on the imaging surface of the VR eyepiece system; wherein
the first lens, the second lens, and the third lens are coaxially arranged;
F1, a combined focal length of the first lens, the connecting assembly, the second lens, and the diffractive optical element, f3, an effective focal length of the third lens, and f, an effective focal length of the VR eyepiece system satisfy: 0.024≤f/(F1−f3)≤0.043; and
F1, the combined focal length of the first lens, the connecting assembly, the second lens and the diffractive optical element, and f3, the effective focal length of the third lens satisfy: −2.066≤f3/F1≤−0.036.

2. The VR eyepiece system according to claim 1, wherein thicknesses of the first glue layer, the linear polarizing plate, the second glue layer, the polarizing reflective film, the third glue layer, the quarter-wave plate and the fourth glue layer are each greater than 0 mm and less than 0.06 mm.

3. The VR eyepiece system according to claim 1, wherein the image-side surface of the third lens is a planar surface.

4. The VR eyepiece system according to claim 1, wherein TTL, an on-axis distance from an eye-side surface of the first lens to the imaging surface of the VR eyepiece system, and ED, an on-axis distance from an eye to the eye-side surface of the first lens satisfy: 1.155≤ED/TTL≤1.221.

5. The VR eyepiece system according to claim 1, wherein EPD, an entrance pupil diameter of the VR eyepiece system, and ImgH, half of a diagonal length of an effective pixel region on the imaging surface of the VR eyepiece system satisfy: 2.715≤ImgH/EPD≤3.062.

6. The VR eyepiece system according to claim 1, wherein f3, the effective focal length of the third lens and fi, an effective focal length of an ith lens satisfy: |f3|<|f1|, and i takes 1, 2.

7. The VR eyepiece system according to claim 1, wherein f, the effective focal length of the VR eyepiece system, and f3, the effective focal length of the third lens satisfy: −15.572≤f3/f≤−1.471.

8. The VR eyepiece system according to claim 1, wherein f1, an effective focal length of the first lens, and f2, an effective focal length of the second lens satisfy: −2.829≤f2/f1≤5.776.

9. The VR eyepiece system according to claim 1, wherein f, the effective focal length of the VR eyepiece system, and TTL, an on-axis distance from an eye-side surface of the first lens to the imaging surface of the VR eyepiece system satisfy: 0.904≤TTL/f≤1.039.

10. The VR eyepiece system according to claim 1, wherein CT1, a center thickness of the first lens, CT2, a center thickness of the second lens, N1, a refractive index of the first lens, and N2, a refractive index of the second lens satisfy: −0.653 mm≤(CT2*N2)−(CT1*N1)≤3.756 mm.

11. The VR eyepiece system according to claim 1, wherein ET1, an edge thickness of the first lens, ET2, an edge thickness of the second lens, and ET3, an edge thickness of the third lens satisfy: 2.100≤(ET1+ET2)/ET3≤5.437.

12. The VR eyepiece system according to claim 1, wherein Tr1r4, an on-axis distance from an eye-side surface of the first lens to the image-side surface of the second lens, and CT3, a center thickness of the third lens satisfy: 1.483≤Tr1r4/CT3≤1.703.

13. The VR eyepiece system according to claim 1, wherein R3, a radius of curvature of an eye-side surface of the second lens, and R5, a radius of curvature of the eye-side surface of the third lens satisfy: −1.283≤R3/R5≤2.857.

14. The VR eyepiece system according to claim 1, wherein TD, an on-axis distance from an eye-side surface of the first lens to the image-side surface of the third lens, and T23, an on-axis distance of an air gap between the second lens and the third lens satisfy: 0.121≤T23/TD≤0.188.
